(19) United States
(12) Patent Application Publication
(10) Pub. No.: US 2026/0056290 A1
(43) Pub. Date: Feb. 26, 2026

(54) DOPPLER RADAR CALIBRATOR

(71) Applicant: Government of the United States of America, as represented by the Secretary of Commerce, Gaithersburg, MD (US)

(72) Inventors: John Robert Jendzurski, Derwood, MD (US); Nicholas George Paulter, JR., Silver Spring, MD (US); Dwight David Atherly Barry, Jefferson, MD (US)

(21) Appl. No.: 19/297,240

(22) Filed: Aug. 12, 2025

Related U.S. Application Data
(60) Provisional application No. 63/686,130, filed on Aug. 22, 2024.

(51) Int. Cl. G01S 7/40; G01S 7/02; G01S 13/58

(52) U.S. Cl. CPC G01S 7/40; G01S 7/027; G01S 13/58

(57) ABSTRACT

A Doppler radar calibrator includes: an operator input device for specifying motion of a Doppler radar calibrator target; a motion controller connected to the operator input device and to the Doppler radar calibrator target, the motion controller receiving information from the operator input device and causing motion of the Doppler radar calibrator target based on the information received; and a Doppler radar calibrator target, wherein the Doppler radar calibrator target moves with a selected frequency and displacement amplitude based on information from the motion controller.

### CROSS-REFERENCE TO RELATED APPLICATION

This application claims the benefit of U.S. Provisional Patent Application Ser. No. 63/686,130 (filed Aug. 22, 2024), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BACKGROUND

The present invention generally relates to the field of Doppler radar calibrators, and more particularly to techniques for testing the performance of through-barrier radio frequency based detection systems.

Through-barrier detection systems are designed to be able to detect the presence of motion through opaque barriers. Specifically, radio frequency-based detection systems are used to detect humans obscured by walls, rubble from collapsed buildings, and other physical barriers. These systems detect small movements such as, but not limited to, motion associated with human heartbeat and respiration, postural sway and other biomechanical motion, and voice.

Currently, humans are often used as targets to test and evaluate the detection capability of through-barrier radar systems. This practice is due to the lack of available surrogate targets for testing and evaluation. However, using human subjects in this manner introduces undesirable aspects to tests and demonstrations of through-barrier radar systems. For example, it is challenging to conduct a truly blind test since the testing operators inevitably know the location of the human subjects, which can inadvertently bias the tests. Furthermore, concerns over the safety of humans in a test environment can limit or preclude the types of tests that can be conducted. The inability to have reproducible tests also detracts from the process, and use of human subjects can involve approval from an institutional review board.

Accordingly, accurate and reproducible tests of through-barrier detection systems require the use of a target that can simulate human motion. Such a test target would preferably be concealable from the testing operators to allow for blind testing and to avoid bias in testing.

It is therefore an objective of the present invention to provide a Doppler radar calibrator for testing the performance of through-barrier radio frequency-based detection systems, thereby overcoming the above-mentioned disadvantages of the prior art at least in part. Accordingly, a Doppler radar calibrator capable of simulating human motion would be advantageous and would be favorably received in the art.

### BRIEF DESCRIPTION

One aspect of the present invention relates to a Doppler radar calibrator. A Doppler radar calibrator can be understood as a device that provides a radio frequency wave having a known Doppler shift. It can be provided that the Doppler radar calibrator comprises an operator input device for specifying motion of a Doppler radar calibrator target. An operator input device can be understood as a device, such as a computer or keyboard or touchscreen, that provides information to the Doppler radar calibrator. One advantage of this arrangement is that it permits an operator to define the desired motion of the Doppler radar calibrator. The Doppler radar calibrator also comprises a motion controller connected to the operator input device and to the Doppler radar calibrator target. A motion controller can be understood as a device that converts information from the operator input device to information for actuating a Doppler radar calibrator target. One advantage of this arrangement is that it provides a means for converting operator input to the motion of the Doppler radar calibrator target. The Doppler radar calibrator also comprises a Doppler radar calibrator target. A Doppler radar calibrator target can be understood as a device that reflects radio frequency waves. One advantage of this arrangement is that it provides an object for producing a Doppler-shifted reflected radio frequency wave for calibration.

One aspect of the present invention relates to a process for operating a Doppler radar calibrator. It can be provided that the process comprises receiving information from an operator input device to define a motion of a Doppler radar calibrator target. The process further comprises transmitting the information to a motion controller. The process further comprises converting the information by the motion controller into information for actuating a Doppler radar calibrator target. The process further comprises actuating the Doppler radar calibrator target by the motion controller to move the Doppler radar calibrator target.

One aspect of the present invention relates to a process for determining whether an unknown Doppler radar system is calibrated. A Doppler radar system can be understood as a device that transmits a radio frequency wave, receives a radio frequency wave reflected from a target, and determines a Doppler shift of the reflected radio frequency wave. It can be provided that the process comprises illuminating a Doppler radar calibrator target with a test source radio frequency wave. One advantage of this arrangement is that it provides a radio frequency source wave for interaction with the Doppler radar calibrator target. The process further comprises actuating the Doppler radar calibrator target by a Doppler radar calibrator to move the Doppler radar calibrator target to produce a test reflected radio frequency wave having a test Doppler shift. The process further comprises receiving the test reflected radio frequency wave by the unknown Doppler radar system. The process further comprises determining a Doppler shift by the unknown Doppler radar system. One advantage of this arrangement is that it allows the unknown Doppler radar system to operate in its intended mode.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a doppler radar calibrator.

FIG. 2 shows, according to some embodiments, a Doppler radar calibrator target.

FIG. 3 shows, according to some embodiments, internal components of the Doppler radar calibrator target shown in FIG. 2.

FIG. 4 shows, according to some embodiments, a doppler radar calibrator.

FIG. 5 shows, according to some embodiments, data acquired for the Doppler radar calibrator shown in FIG. 4.

FIG. 6 shows, according to some embodiments, testing an unknown Doppler radar system with the Doppler radar calibrator.

### DETAILED DESCRIPTION

A detailed description of one or more embodiments is presented herein by way of exemplification and not limitation.

Conventional Doppler radar calibrators for testing the performance of through-barrier radio frequency-based detection systems are typically static devices that do not provide for motion of a calibration target. Such devices are inadequate for accurately testing Doppler radar systems since motion of the target is required for a Doppler shift to be imparted onto a reflected radio frequency wave.

The Doppler radar calibrator overcomes these deficiencies by providing motion to a radar calibration target. It has been discovered that a Doppler radar calibrator can be used to test the performance of Doppler radar systems. One advantage of a Doppler radar calibrator is that it enables a user to specify the motion of a Doppler radar calibrator target. The operator input device of the Doppler radar calibrator provides a means for a user to provide information to the Doppler radar calibrator that is converted by the motion controller to control the motion of a Doppler radar calibrator target. Another advantage of a Doppler radar calibrator is that it provides a way for a Doppler radar calibrator target to be actuated. The motion controller of a Doppler radar calibrator is connected to a Doppler radar calibrator target to impart motion onto the target.

In an embodiment, a Doppler radar calibrator 203 comprises an operator input device 200 for specifying motion of a Doppler radar calibrator target 202. In an embodiment, the Doppler radar calibrator 203 also comprises a motion controller 201 connected to the operator input device 200 and to the Doppler radar calibrator target 202, the motion controller 201 receiving information from the operator input device 200 and causing motion of the Doppler radar calibrator target 202 based on the information received. In an embodiment, the Doppler radar calibrator 203 further comprises a Doppler radar calibrator target 202. In an embodiment, the Doppler radar calibrator target 202 moves with a frequency from 0.1 Hz to 10 Hz. In an embodiment, the Doppler radar calibrator target 202 moves with a displacement amplitude from 0.5 cm to 2 cm. In an embodiment, the motion controller 201 is in electrical communication with the operator input device 200. In an embodiment, the motion controller 201 causes the Doppler radar calibrator target 202 to move in accordance with one or more motion profiles comprising sinusoidal, sawtooth, or any motion profile such that the Doppler radar calibrator target 202 remains operable. In an embodiment, the motion of the Doppler radar calibrator target 202 causes a Doppler shift in a radio frequency wave reflected from the Doppler radar calibrator target 202. In an embodiment, the Doppler radar calibrator target 202 interacts with the radio frequency wave by reflection and scattering. In an embodiment, the reflection and scattering of the radio frequency wave from the Doppler radar calibrator target 202 is independent of the orientation of the Doppler radar calibrator target 202 with respect to a Doppler radar under test.

The Doppler radar calibrator 203 overcomes deficiencies in conventional devices by providing motion to a radar calibration target 202. It has been discovered that a Doppler radar calibrator 203 can be used to test the performance of Doppler radar systems. One advantage of a Doppler radar calibrator 203 is that it enables a user to specify the motion of a Doppler radar calibrator target 202. The operator input device 200 of the Doppler radar calibrator 203 provides a user to provide information to the Doppler radar calibrator 203. The information from the operator input device 200 is received by the motion controller 201. The operator input device 200 can be implemented using any devices such as a keyboard, mouse, touchscreen, and the like. Some embodiments of the operator input device 200 include voice recognition modules, motion sensors, or other input methods. Another advantage of the Doppler radar calibrator 203 is that it provides a way for a Doppler radar calibrator target 202 to be actuated. The motion controller 201 of a Doppler radar calibrator 203 is connected to a Doppler radar calibrator target 202 to impart motion onto the target 202. The motion controller 201 converts the information from the operator input device 200 to actuate the Doppler radar calibrator target 202. The motion controller 201 can be implemented using hardware such as an electronic control board with motion control drivers and motion actuators. Other implementations of the motion controller 201 can include mechanical, hydraulic, pneumatic, magnetic, thermal, and any other systems that can impart motion for actuating the target. The Doppler radar calibrator target 202 can be implemented as, e.g., a segmented sphere with a plurality of motion actuators connected to the motion controller 201, one actuator for each segment, and that the motion controller 201 causes each segment of the Doppler radar calibrator target 202 to move simultaneously, synchronously, and asynchronously to cause the target to change shape, e.g., to expand and to contract. Alternatively, the Doppler radar calibrator target 202 can be implemented as an arbitrary shaped pliable member such as a reversibly expandable bladder that can be of arbitrary shape.

The operator input device 200 allows an operator to easily and to accurately specify the motion of the target 202. The motion controller 201 enables the Doppler radar calibrator 203 to achieve a desired motion profile for the Doppler radar calibrator target 202. The Doppler radar calibrator target 202 is reflective at radio frequencies, and the motion of the Doppler radar calibrator target 202 imparts a known Doppler shift onto a reflected radio frequency wave, thus creating a calibration source for testing Doppler radar systems.

The motion controller 201 can be in electromagnetic communication with the operator input device 200. Electromagnetic communication can include electrical as well as optical. Electrical communication can be implemented using wires, cables, printed circuit boards, and other hardware for communicating information electronically. The motion controller 201 can control the Doppler radar calibrator target 202 to move in accordance with a motion profile. The motion profile can be, for example, sinusoidal, sawtooth, or random, or any motion profile and can be specified using the operator input device 200. Sinusoidal motion profiles can be used to simulate periodic movement such as human heartbeat. Sawtooth motion profiles can be used to simulate motions that include an abrupt change in direction, such as a quick inhale followed by a slow exhale of human breathing. Random motion profiles can be used to simulate motions such as human postural sway. The Doppler radar calibrator target 202 can mimic human biometrics. Biometric motion can be simulated using motion profiles to represent various human motions. Examples of human biometric motion include heartbeat and respiration. The motion of the Doppler radar calibrator target 202 can cause a Doppler shift in a radio frequency wave reflected from the Doppler radar calibrator target 202. The Doppler radar calibrator target 202 can interact with the radio frequency wave by reflection and scattering. The Doppler radar calibrator target 202 can reflect the radio frequency wave. The angle of reflection of the radio frequency wave from the Doppler radar calibrator target 202 can be isotropic. The Doppler radar calibrator target 202 can be a reversibly expandable bladder. A bladder can be made from any suitable material that is reflective to radio frequency waves. The Doppler radar calibrator target 202 can be segmented. Each segment of the Doppler radar calibrator target 202 can be connected to a motion actuator. The motion controller 201 can cause motion of the Doppler radar calibrator target 202 by simultaneous, synchronous, or asynchronous actuation of a plurality of motion actuators.

The electrical communication between the motion controller 201 and the operator input device 200 enables the Doppler radar calibrator 203 to be compact and reliable. Motion profiles allow the Doppler radar calibrator 203 to simulate a wide variety of motions. Simulating human biometrics enables the Doppler radar calibrator 203 to provide a life-like calibration target for Doppler radar systems. The motion of the Doppler radar calibrator target 202 produces a Doppler shift in a radio frequency wave, which can be measured to calibrate an unknown Doppler radar system. Reflection and scattering are the primary means by which a radio frequency wave interacts with the Doppler radar calibrator target 202, and the isotropic nature of the reflection allows the Doppler radar calibrator target 202 to be independent of orientation with respect to the radar under test. A reversibly expandable bladder allows the Doppler radar calibrator target 202 to be sturdy, reliable, and compact, and segmenting the Doppler radar calibrator target 202 allows for a wide variety of motions to be simulated. Simultaneous actuation of segments enables a more uniform and reliable motion of the Doppler radar calibrator target 202.

The operator input device 200 receives input from an operator that is to be provided to the Doppler radar calibrator 203. In an embodiment, the operator loads the motion profile into the motion controller 201, disconnects the operator input device 200, and causes the motion to be activated by delivering electrical power to the motion controller 201. The information from the operator input device 200 is communicated from the operator input device 200 and received by the motion controller 201. The operator input device 200 can be a device such as a keyboard, mouse, touchscreen, and the like. Other possible implementations of the operator input device 200 include voice recognition modules, motion sensors, or other input hardware and software. The operator input device 200 can be electrically connected to the motion controller 201. The electrical connection can be implemented using wires, cables, printed circuit boards, and the like. Wireless communication can be used. The operator input device 200 allows an operator to easily and to accurately define a motion profile for the Doppler radar calibrator target 202 by providing information to the motion controller 201. The operator input device 200 provides a user-friendly interface for accurately defining how the target will move, and the electrical connection between the operator input device 200 and the motion controller 201 enables a compact, reliable, and robust design. The input information can include type of motion, expansion rate, contraction rate, and the like.

The motion controller 201 receives information from the operator input device 200 and causes motion of the Doppler radar calibrator target 202 based on the information received. The motion controller 201 converts the information from the operator input device 200 to actuate the Doppler radar calibrator target 202. The motion controller 201 can be implemented using any means such as an electronic control board with motion control drivers and motion actuators. Other implementations of the motion controller 201 can include mechanical, hydraulic, pneumatic, and magnetic systems for actuating the target. The motion controller 201 can be electrically connected to the operator input device 200. The motion controller 201 can be electrically connected to the Doppler radar calibrator target 202. These electrical connections can be implemented using wires, cables, printed circuit boards, or any other means, e.g., wireless communication. The motion controller 201 enables the Doppler radar calibrator 203 to achieve a desired motion profile for the Doppler radar calibrator target 202, which provides a test target for calibrating Doppler radar systems. The motion controller 201 provides for precise actuation of the Doppler radar calibrator target 202 based on the information from the operator input device 200, and the electrical connections of the motion controller 201 allow for a compact and reliable design.

The Doppler radar calibrator target 202 is connected to the motion controller 201 and is actuated to move by the motion controller 201. The Doppler radar calibrator target 202 is reflective at radio frequencies, and the motion of the Doppler radar calibrator target 202 imparts a known Doppler shift onto a reflected radio frequency wave. When used to test an unknown Doppler radar system 204, the known Doppler shift can be referred to as a test Doppler shift 207. The Doppler radar calibrator target 202 can be implemented as a segmented sphere with a plurality of motion actuators connected to the motion controller 201, one actuator for each segment. The motion controller 201 causes each segment of the Doppler radar calibrator target 202 to move simultaneously, synchronously, or asynchronously to cause the target to expand and contract in a desired form or way. Alternatively, the Doppler radar calibrator target 202 can be implemented as a reversibly expandable bladder that can be of arbitrary shape. The Doppler radar calibrator target 202 can move with a frequency from 0.001 Hz to 20 000 Hz, specifically from 0.1 Hz to 100 Hz, and more specifically from 0.1 Hz to 10 Hz or as user-specified such that the Doppler radar calibrator target 202 remains operable and can move with a displacement amplitude from 0.1 mm to 10 m, specifically from 0.1 cm to 1 m, and more specifically from 0.5 cm to 2 cm or as user-specified such that the Doppler radar calibrator target 202 remains operable.

The Doppler radar calibrator target 202 provides a target having motion for use in calibrating Doppler radar systems. The connection to the motion controller 201 enables the Doppler radar calibrator 203 to accurately actuate the Doppler radar calibrator target 202. A segmented sphere allows for a consistent radio frequency reflection independent of the orientation of the Doppler radar calibrator target 202 relative to the radar under test, and a reversibly expandable bladder provides for a compact, robust, and reliable design. The frequency and displacement amplitude of the motion of the Doppler radar calibrator target 202 can be selected to simulate a wide variety of human motions.

A segmented Doppler radar calibrator target 202 is a device that reflects radio frequency waves and can include a plurality of pieces connected to form a desired shape, e.g., a spherical shape. The outer surface of the segmented Doppler radar calibrator target 202 is covered by a material, such as a metal, that is reflective at radio frequencies. The internal space of the segmented Doppler radar calibrator target 202 includes a plurality of motion actuators, each motion actuator connected to a segment of the Doppler radar calibrator target 202. The motion actuators are electrically connected to and controlled by the motion controller 201. The motion controller 201 simultaneously actuates the plurality of motion actuators, thereby imparting motion onto the Doppler radar calibrator target 202.

The outer surface of the Doppler radar calibrator target 202 comprises a surface covering, such as a coating, or is constructed of a material, such that radio frequency waves are reflected. The covering can be continuous or discontinuous. The outer surface is shaped and arranged to present a substantially constant reflection of radio frequency waves at all incident angles of the radio frequency waves. The Doppler radar calibrator target 202 is connected to the motion controller 201 and moves based on information from the motion controller 201. The plurality of motion actuators of the Doppler radar calibrator target 202 can be electromechanical devices that convert electrical energy to mechanical energy to impart motion. Each motion actuator is connected to the motion controller 201 and to a segment of the Doppler radar calibrator target 202. The motion actuators can be linear actuators, such as a motor that turns a screw, that extend and retract to push and pull the segments.

The Doppler radar calibrator target 202 can be spherical or another shape. The outer surface of the cube can be comprised of a plurality of pieces interconnected to form the cubic shape. The pieces can be made from a material, such as a metal, that is reflective to radio frequency waves. Each piece of the cube is connected to at least one motion actuator located on an inner surface of the Doppler radar calibrator target 202. The Doppler radar calibrator target 202 can be implemented in a variety of shapes, and the motion imparted onto the Doppler radar calibrator target 202 by the motion controller 201 can be varied to simulate different types of motion. The motion of the Doppler radar calibrator target 202 causes a Doppler shift in a radio frequency wave reflected from the Doppler radar calibrator target 202.

In an embodiment, the Doppler radar calibrator target 202 is a cube. The outer surface of the cube can be comprised of a plurality of pieces interconnected to form the cubic shape. The pieces can be made from a material, such as a metal, that is reflective to radio frequency waves. Each piece of the cube is connected to at least one motion actuator located on an inner surface of the Doppler radar calibrator target 202. The motion actuators are electrically connected to and controlled by the motion controller 201. The motion controller 201 simultaneously actuates the motion actuators to cause the Doppler radar calibrator target 202 to move.

In an embodiment, the Doppler radar calibrator target 202 is implemented as a pyramid. The motion imparted to a pyramidal Doppler radar calibrator target 202 by the motion controller 201 can cause the Doppler radar calibrator target 202 to move toward and away from an unknown Doppler radar system 204. Alternatively, the motion controller 201 can impart motion that causes the Doppler radar calibrator target 202 to rotate.

In an embodiment, the Doppler radar calibrator target 202 is a cylinder. The cylindrical Doppler radar calibrator target 202 can be implemented, for example, as a segmented right circular cylinder with a plurality of segments arranged circumferentially. Each segment can be connected to a motion actuator that causes the segment to translate. The motion controller 201 simultaneously actuates the plurality of motion actuators to cause the Doppler radar calibrator target 202 to expand and contract.

The Doppler radar calibrator target 202 can further be implemented as a cone, a rectangular prism, or any other three-dimensional shape. The outer surface of the cube can be comprised of a plurality of pieces interconnected to form the cubic shape. The pieces can be made from a material, such as a metal, that is reflective to radio frequency waves. Each piece of the cube is connected to at least one motion actuator located on an inner surface of the Doppler radar calibrator target 202. The motion controller 201 can impart motion to the Doppler radar calibrator target 202 to simulate any motion.

In an embodiment, the Doppler radar calibrator target 202 is a reversibly expandable bladder. The reversibly expandable bladder can be made from any suitable material that is reflective to radio frequency waves and that can expand and contract based on commands from the motion controller 201. The motion of the Doppler radar calibrator target 202 causes a Doppler shift in a radio frequency wave reflected from the Doppler radar calibrator target 202. The reversibly expandable bladder can be implemented, for example, as a cube. The motion imparted to a cubic Doppler radar calibrator target 202 by the motion controller 201 can cause the Doppler radar calibrator target 202 to expand and contract in a plurality of directions. Alternatively, the motion controller 201 can impart motion that causes the Doppler radar calibrator target 202 to rotate, or to move toward and away from an unknown Doppler radar system 204. A pyramidal shape can also be used for a Doppler radar calibrator target 202. The motion controller 201 can be implemented using a device, such as a pump, that moves a fluid into and out of the Doppler radar calibrator target 202 to cause it to expand and contract. The motion controller 201 can be programmed to achieve a variety of expansion and contraction patterns, such as sinusoidal, sawtooth, or random. The Doppler radar calibrator target 202 can further be implemented as a cylindrical reversibly expandable bladder. For example, a cylindrical Doppler radar calibrator target 202 can be actuated to simulate the expansion and contraction of a human chest during respiration. Alternatively, the cylindrical Doppler radar calibrator target 202 can be actuated to rotate. The reversibly expandable bladder can further be implemented in a variety of shapes, such as a cone, a rectangular prism, or any other three-dimensional shape. The motion controller 201 can actuate the Doppler radar calibrator target 202 to simulate a wide variety of motion profiles.

In an embodiment, the Doppler radar calibrator 203 is used to determine whether an unknown Doppler radar system 204 is calibrated. The unknown Doppler radar system 204 can be any device, piece of equipment, or system that is designed to measure Doppler shift. The unknown Doppler radar system 204 can be used to determine, for example, the speed of a moving object, or the distance to a moving object, or the presence of motion. The unknown Doppler radar system 204 transmits a source radio frequency wave and receives a reflected radio frequency wave. The unknown Doppler radar system 204 (or can be connected to a unit, e.g., analyzer 209 that) compares the source radio frequency wave with the reflected radio frequency wave to determine a Doppler shift. The source wave can be the same as, or different from, a test source radio frequency wave 205. The Doppler radar calibrator 203 can be used to determine whether an unknown Doppler radar system 204 is calibrated. The Doppler radar calibrator 203 includes a Doppler radar calibrator target 202 that is actuated to move, thereby generating a reflected radio frequency wave having a known Doppler shift (e.g., test Doppler shift 207). The reflected wave from the Doppler radar calibrator target 202, which is a test reflected radio frequency wave 206, has a test Doppler shift 207. The unknown Doppler radar system 204 receives the test reflected radio frequency wave 206 and measures a Doppler shift. The Doppler shift 208 measured by the unknown Doppler radar system 204 can then be compared to the test Doppler shift 207. If the Doppler shift 208 measured by the unknown Doppler radar system 204 matches the test Doppler shift 207, then the unknown Doppler radar system 204 is calibrated. Alternatively, if the Doppler shift 208 measured by the unknown Doppler radar system 204 does not match the test Doppler shift 207, then the unknown Doppler radar system 204 is not calibrated. The unknown Doppler radar system 204 can be any Doppler radar system, e.g., continuous wave Doppler radar systems, frequency modulated continuous wave Doppler radar systems, and pulsed Doppler radar systems. The unknown Doppler radar system 204 can operate at any suitable frequency. The unknown Doppler radar system 204 can be used to measure the Doppler shift of any target.

The unknown Doppler radar system 204 provides a device for measuring Doppler shift and can be any Doppler radar operating at any suitable frequency. The ability to compare the Doppler shift 208 determined by the unknown Doppler radar system 204 with the test Doppler shift 207 enables the Doppler radar calibrator 203 to determine whether the unknown Doppler radar system 204 is calibrated.

The test source RF wave 205 illuminates the Doppler radar calibrator target 202. The test source RF wave 205 can be generated by any source such as an RF signal generator. The test source RF wave 205 can be a continuous wave or pulsed and can be any suitable waveform. The test source RF wave 205 can have any suitable frequency. The frequency of the test source RF wave 205 can be, for example, in a range from 1 MHz to 100 GHz. The test source RF wave 205 can be transmitted using an antenna. For example, the test source RF wave 205 can be transmitted by a horn antenna, a patch antenna, a dipole antenna, or any other antenna that can transmit and receive the test source RF wave 205. The test source RF wave 205 can be polarized, e.g., linearly polarized or circularly polarized. The test source RF wave 205 is reflected and scattered by the Doppler radar calibrator target 202 to produce a test reflected radio frequency wave 206. The test reflected radio frequency wave 206 has a test Doppler shift 207. The test Doppler shift 207 is based on the frequency of actuation of the Doppler radar calibrator target 202. The test reflected radio frequency wave 206 is received and analyzed by an unknown Doppler radar system 204, an analyzer 209, or the Doppler radar calibrator 203 to determine whether the unknown Doppler radar system 204 is calibrated. The test source RF wave 205 can be generated by the unknown Doppler radar system 204. Alternatively, the test source RF wave 205 can be generated by an independent source, such as an RF signal generator. The test source RF wave 205 can be used to test a wide range of Doppler radar systems. The test source RF wave 205 can be varied in frequency and polarization to provide a versatile source for calibrating Doppler radar systems. The test source RF wave 205 produces a test reflected RF wave 206 having a known Doppler shift 207, which allows for a determination to be made as to whether an unknown Doppler radar system 204 is calibrated.

The test reflected RF wave 206 is produced when a test source RF wave 205 illuminates a Doppler radar calibrator target 202. The test source RF wave 205 can be generated by any suitable source such as a radio frequency signal generator or a Doppler radar under test. The Doppler radar calibrator target 202 is moved by the Doppler radar calibrator 203. The motion of the Doppler radar calibrator target 202 imparts a Doppler shift onto the test source RF wave 205, creating the test reflected RF wave 206, which has a test Doppler shift 207. The test reflected RF wave 206 is received by the unknown Doppler radar system 204. The test reflected RF wave 206 can have a frequency in a range from 1 MHz to 100 GHz. The test reflected RF wave 206 can have a pulse duration that between 10 ps to 100 ns. The test reflected RF wave 206 can be linearly polarized, and alternatively the test reflected RF wave 206 can be circularly polarized. The test Doppler shift 207 can be positive, and alternatively the test Doppler shift 207 can be negative. The test Doppler shift 207 is dependent on the direction of motion of the Doppler radar calibrator target 202 relative to the unknown Doppler radar system 204. The test reflected RF wave 206 can be received by the same antenna that transmitted the test source RF wave 205, and alternatively the test reflected RF wave 206 can be received by an antenna that is different from the antenna that transmitted the test source RF wave 205. The Doppler radar calibrator 203 can be used to determine whether the unknown Doppler radar system 204 is calibrated by comparing the Doppler shift 208 determined by the unknown Doppler radar system 204 to the known test Doppler shift 207 of the test reflected RF wave 206. The wide bandwidth of the test reflected RF wave 206 allows the test reflected RF wave 206 to be used to test a wide variety of Doppler radar systems, and the narrow pulse duration of the test reflected RF wave 206 permits the Doppler radar calibrator target 202 to be located at a precise distance from the unknown Doppler radar system 204. The variable polarization of the test reflected RF wave 206 allows the test reflected RF wave 206 to be used to evaluate the polarization response of the unknown Doppler radar system 204. The Doppler shift 207 of the test reflected RF wave 206 provides for calibrating the ability of the unknown Doppler radar system 204 to measure Doppler shift.

The test Doppler shift 207 is a shift in the frequency of the test reflected RF wave 206 compared to the test source RF wave 205. The test reflected RF wave 206 is produced when a test source RF wave 205 illuminates a Doppler radar calibrator target 202. The Doppler radar calibrator target 202 is actuated by a Doppler radar calibrator 203. The motion of the Doppler radar calibrator target 202 imparts a Doppler shift onto the test source RF wave 205, creating the test reflected RF wave 206. The test Doppler shift 207 is dependent on the frequency of actuation of the Doppler radar calibrator target 202 and the relative velocity of the Doppler radar calibrator target 202 with respect to the unknown Doppler radar system 204. The Doppler radar calibrator 203 actuates the Doppler radar calibrator target 202 to produce a test Doppler shift 207. The test Doppler shift 207 can be positive, and alternatively the test Doppler shift 207 can be negative. The sign of the test Doppler shift 207 is dependent on the direction of motion of the Doppler radar calibrator target 202 relative to the unknown Doppler radar system 204. The test Doppler shift 207 is used to determine whether the unknown Doppler radar system 204 is calibrated. The unknown Doppler radar system 204 receives the test reflected RF wave 206 and determines a Doppler shift 208. The Doppler shift 208 determined by the unknown Doppler radar system 204 is compared with the test Doppler shift 207. If the Doppler shift 208 determined by the unknown Doppler radar system 204 matches the test Doppler shift 207, then the unknown Doppler radar system 204 is considered calibrated. The Doppler radar calibrator 203 can include an operator input device 200 that specifies the test Doppler shift 207. The operator input device 200 can transmit the information to a motion controller 201, the motion controller 201 actuating the Doppler radar calibrator target 202 to produce the test Doppler shift 207. The test Doppler shift 207 can have a value, e.g., from 0.1 Hz to 10 Hz. The test Doppler shift 207 can correspond to a displacement amplitude of the Doppler radar calibrator target 202 in a range, e.g., from 0.5 cm to 2 cm. The test Doppler shift 207 provides a known Doppler shift for use in calibrating Doppler radar systems. The test Doppler shift 207 can be controlled by the operator to generate a variety of Doppler shifts for testing the performance of the unknown Doppler radar system 204.

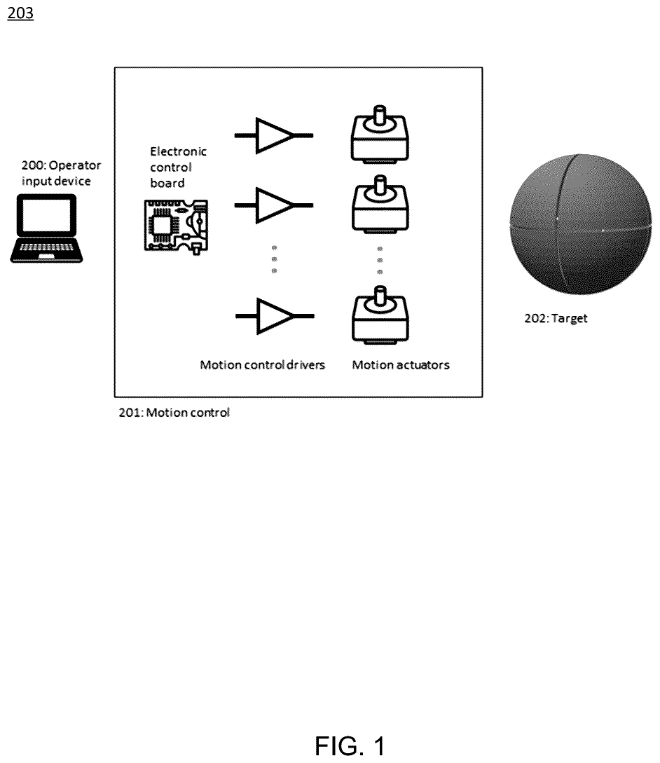

According to an embodiment, FIG. 1 shows a Doppler radar calibrator 203. The Doppler radar calibrator 203 includes an operator input device 200, a motion controller 201, and a Doppler radar calibrator target 202. The Doppler radar calibrator 203 is a system for testing the performance of Doppler radar systems. The operator input device 200 allows an operator to specify the motion of the Doppler radar calibrator target 202. The operator input device 200 can be implemented as a laptop computer that is electrically connected to the motion controller 201. The motion controller 201 receives information from the operator input device 200 and converts the information to control a plurality of motion actuators. The motion controller 201 can be implemented as an electronic control board. The electronic control board includes an integrated circuit that receives data from the operator input device 200. The integrated circuit of the motion controller 201 converts the received data to output signals for controlling a plurality of motion control drivers. Each motion control driver is electrically connected to a motion actuator. The motion actuators can be implemented as stepper motors. Each stepper motor is electrically connected to a segment of the Doppler radar calibrator target 202. The motion actuators are arranged to simultaneously actuate the segments of the Doppler radar calibrator target 202 to cause the Doppler radar calibrator target 202 to move. The motion of the Doppler radar calibrator target 202 causes a Doppler shift in a radio frequency wave reflected from the Doppler radar calibrator target 202.

The Doppler radar calibrator target 202 can be implemented as a segmented sphere, and alternatively, the Doppler radar calibrator target 202 can have an arbitrary shape. The Doppler radar calibrator target 202 is covered with a material that reflects radio frequency waves. The operator can specify the motion of the Doppler radar calibrator target 202 using the operator input device 200 to define a motion profile. The motion profile can be sinusoidal, or sawtooth, or random, or any other motion profile. The operator input device 200 allows for versatile control of the Doppler radar calibrator 203. The motion controller 201 enables the Doppler radar calibrator target 202 to be actuated precisely and repeatedly. The stepper motors provide a robust and reliable way to impart motion onto the Doppler radar calibrator target 202. In an embodiment, the spherical shape of the Doppler radar calibrator target 202 ensures that the Doppler radar calibrator target 202 has a substantially constant radar cross section at all orientations of the Doppler radar calibrator target 202 with respect to a Doppler radar under test.

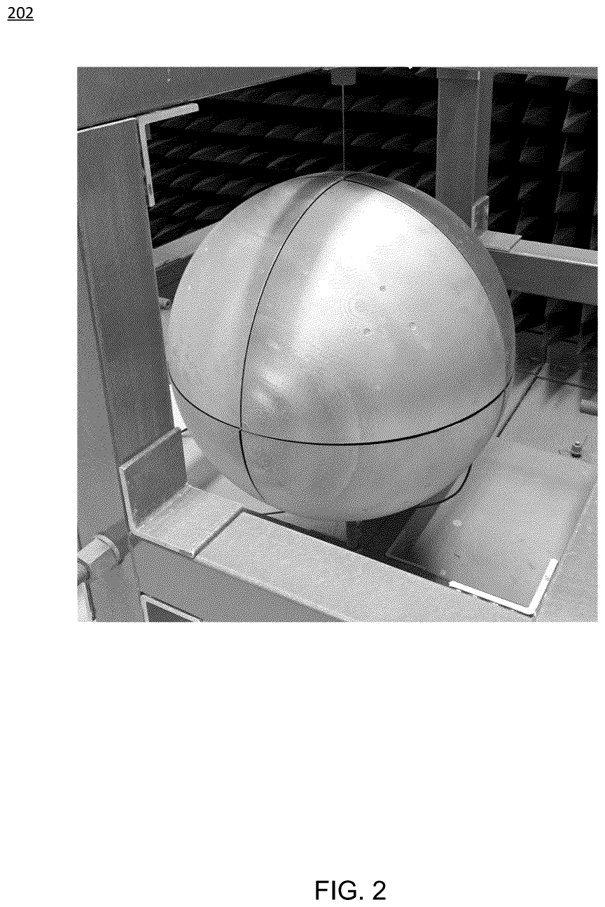

According to an embodiment, FIG. 2 shows a Doppler radar calibrator target 202. The Doppler radar calibrator target 202 is a component of a Doppler radar calibrator 203. The Doppler radar calibrator target 202 is reflective at radio frequencies, and the motion of the Doppler radar calibrator target 202 imparts a known Doppler shift onto a reflected radio frequency wave. The Doppler radar calibrator target 202 is shown as a segmented sphere, but it can have an arbitrary shape. The Doppler radar calibrator target 202 is covered with a material that reflects radio frequency waves. The Doppler radar calibrator target 202 is implemented as a segmented sphere having a plurality of pieces that are interconnected to form a spherical shape. Each piece is connected to at least one motion actuator, and each motion actuator is electrically connected to and controlled by a motion controller 201. The motion controller 201 simultaneously actuates the plurality of motion actuators to cause the Doppler radar calibrator target 202 to expand and contract. The outer surface of the Doppler radar calibrator target 202 is covered with a material that reflects radio frequency waves. The motion actuators are located on an inner surface of the Doppler radar calibrator target 202 and are not visible in FIG. 2. The Doppler radar calibrator target 202 can move with a frequency from 0.1 Hz to 10 Hz and a displacement amplitude from 0.5 cm to 2 cm. The motion of the Doppler radar calibrator target 202 can be in accordance with one or more motion profiles. The motion profile can be sinusoidal, or sawtooth, or random, or any other motion profile. The Doppler radar calibrator target 202 can mimic human biometrics. An example of human biometric motion is the motion of the human chest during respiration. The segmented spherical shape of the Doppler radar calibrator target 202 ensures that the Doppler radar calibrator target 202 has a substantially constant radar cross section at all orientations of the Doppler radar calibrator target 202 with respect to a Doppler radar under test.

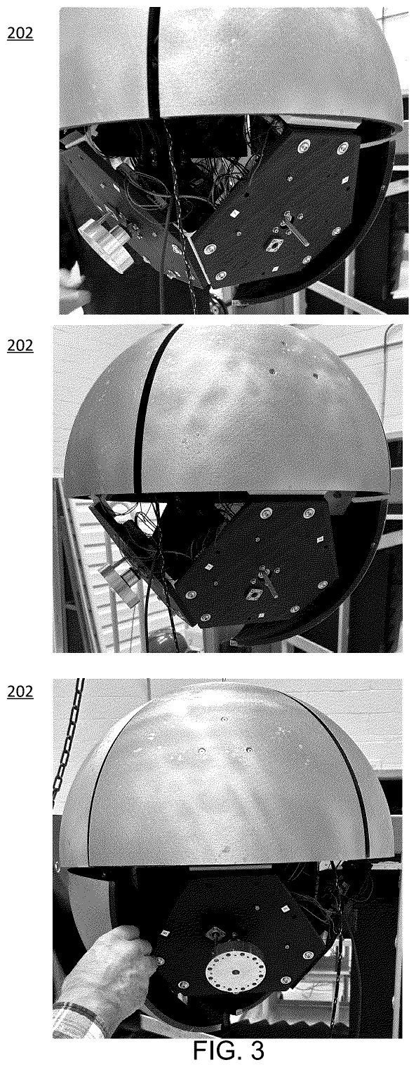

According to an embodiment, FIG. 3 shows the interior of the Doppler radar calibrator target 202 shown in FIG. 2. The Doppler radar calibrator target 202 is shown in a partially disassembled state to reveal internal components. The Doppler radar calibrator target 202 is a component of a Doppler radar calibrator 203. The Doppler radar calibrator target 202 is implemented as a segmented sphere having a plurality of pieces that are interconnected to form a spherical shape. Each piece is connected to at least one motion actuator, and each motion actuator is electrically connected to and controlled by the motion controller 201. The motion controller 201 simultaneously actuates the plurality of motion actuators to cause the Doppler radar calibrator target 202 to expand and contract. A segment of the Doppler radar calibrator target 202 is shown disconnected to reveal the connection between a motion actuator and the segment. The motion actuator is a linear actuator that can extend and retract. The motion actuator is electrically connected to the motion controller 201. A plurality of wires connecting the motion actuators to the motion controller 201 is shown. The segmented spherical shape of the Doppler radar calibrator target 202 ensures that the Doppler radar calibrator target 202 has a substantially constant radar cross section at all orientations of the Doppler radar calibrator target 202 with respect to a Doppler radar under test.

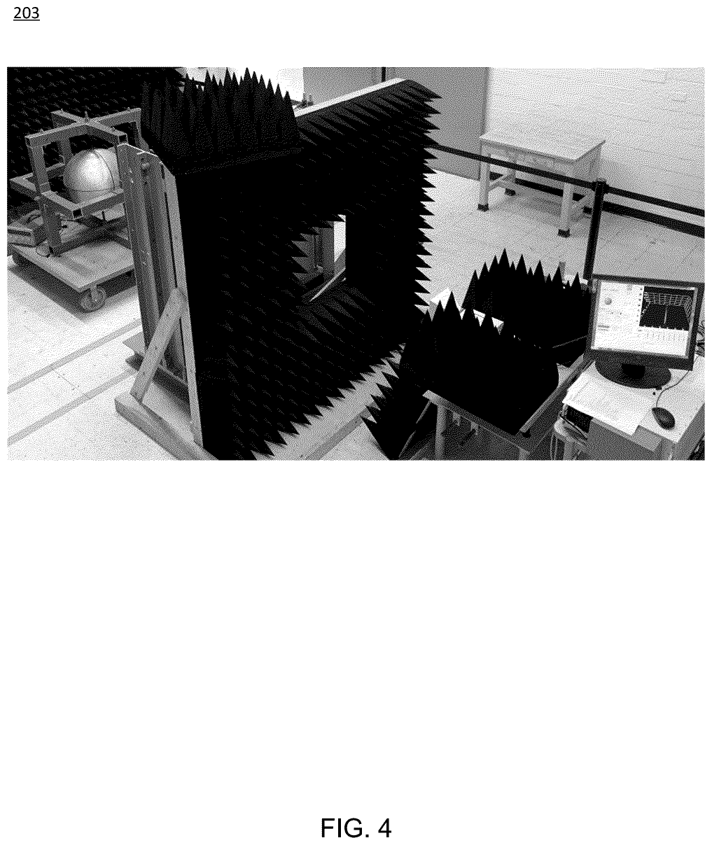

According to an embodiment, FIG. 4 shows a Doppler radar calibrator 203 situated in a test environment for evaluating an unknown Doppler radar system 204. The Doppler radar calibrator 203 includes an operator input device 200, a motion controller 201, and a Doppler radar calibrator target 202. The operator input device 200 is shown as a laptop. The Doppler radar calibrator target 202 is reflective at radio frequencies, and the motion of the Doppler radar calibrator target 202 imparts a known Doppler shift onto a reflected radio frequency wave. The Doppler radar calibrator target 202 is shown as a segmented sphere, but it can have an arbitrary shape. The Doppler radar calibrator target 202 is covered with a material that reflects radio frequency waves. The Doppler radar calibrator target 202 is connected to the motion controller 201. The motion controller 201 is not visible in FIG. 4. The Doppler radar calibrator target 202 is shown mounted on a low-reflectivity stand to minimize spurious RF reflections that can interfere with a measurement. The test environment includes a plurality of radio frequency absorber panels that minimize radio frequency wave reflections from the walls, ceiling, and floor. The radio frequency absorber panels can be pyramidal in shape. The unknown Doppler radar system 204 can be located at a fixed distance from the Doppler radar calibrator target 202. The unknown Doppler radar system 204 transmits a test source radio frequency wave 205 that illuminates the Doppler radar calibrator target 202. The test source radio frequency wave 205 can be a continuous wave or pulsed. The Doppler radar calibrator target 202 reflects and scatters the test source radio frequency wave 205 to produce a test reflected radio frequency wave 206 that is received by the unknown Doppler radar system 204. The test reflected radio frequency wave 206 has a test Doppler shift 207. The test Doppler shift 207 is based on the motion imparted to the Doppler radar calibrator target 202 by the Doppler radar calibrator 203. The Doppler shift measured by the unknown Doppler radar system 204 is compared to the known test Doppler shift 207. If the Doppler shift measured by the unknown Doppler radar system 204 matches the test Doppler shift 207 then the unknown Doppler radar system 204 is considered calibrated.

In an embodiment, a process for operating a Doppler radar calibrator 203 comprises receiving information from an operator input device 200 to define a motion of a Doppler radar calibrator target 202. In an embodiment, the process further comprises transmitting the information to a motion controller 201. In an embodiment, the process further comprises converting the information by the motion controller 201 into information for actuating a Doppler radar calibrator target 202. In an embodiment, the process further comprises actuating the Doppler radar calibrator target 202 by the motion controller 201 to move the Doppler radar calibrator target 202 with a frequency from 0.1 Hz to 10 Hz. In an embodiment, the Doppler radar calibrator target 202 further moves with a displacement amplitude from 0.5 cm to 2 cm. In an embodiment, the operator input device 200 is in electrical communication with the motion controller 201. In an embodiment, the process further comprises actuating the Doppler radar calibrator target 202 in accordance with a motion profile comprising: sinusoidal, sawtooth, random, or a combination comprising at least one of the foregoing waveforms. In an embodiment, the motion of the Doppler radar calibrator target 202 causes a Doppler shift in a radio frequency wave reflected from the Doppler radar calibrator target 202. In an embodiment, the process further comprises illuminating the Doppler radar calibrator target 202 with a radio frequency wave. In an embodiment, the process further comprises detecting the radio frequency wave reflected from the Doppler radar calibrator target 202.

Conventional methods for testing the performance of through-barrier radio frequency based detection systems use human subjects, which introduces undesirable aspects to the process. It is therefore desirable to have a process for operating a Doppler radar calibrator 203 that provides motion to a Doppler radar calibrator target 202 to mimic human motion. The process receives information from an operator input device 200 to define a motion of a Doppler radar calibrator target 202. The operator input device 200 can be, for example, a computer keyboard, or a computer mouse, or a touch screen, or any other input device. The information from the operator input device 200 defines the frequency of motion of the Doppler radar calibrator target 202, and also the displacement amplitude of the Doppler radar calibrator target 202. The information from the operator input device 200 can further define the motion profile of the Doppler radar calibrator target 202. The motion profile can be sinusoidal, or sawtooth, or random, or any other profile. The process transmits the information to a motion controller 201. The information can be transmitted electronically using wires, cables, or printed circuit boards. The motion controller 201 converts the information into information for actuating a Doppler radar calibrator target 202. The motion controller 201 can be implemented using an electronic control board including a microprocessor, motion control drivers, and digital-to-analog converters. The motion controller 201 can be programmed to convert the information from the operator input device 200 to sinusoidal motion of the Doppler radar calibrator target 202, or sawtooth motion, or random motion. The motion controller 201 then actuates the Doppler radar calibrator target 202 to move the Doppler radar calibrator target 202 with a frequency from 0.1 Hz to 10 Hz and with a displacement amplitude from 0.5 cm to 2 cm. The motion controller 201 is electrically connected to the Doppler radar calibrator target 202. The Doppler radar calibrator target 202 can be implemented as a segmented sphere, or a reversibly expandable bladder. The motion controller 201 can actuate the Doppler radar calibrator target 202 by imparting motion onto a plurality of segments of the Doppler radar calibrator target 202. The motion controller 201 can simultaneously actuate the plurality of segments of the Doppler radar calibrator target 202 to cause the Doppler radar calibrator target 202 to expand and contract. The operator input device 200 provides an operator a way to accurately specify how the Doppler radar calibrator target 202 moves. The motion controller 201 provides a means for converting the operator input to actuation of the Doppler radar calibrator target 202. The Doppler radar calibrator target 202 provides producing a reflected radio frequency wave having a known Doppler shift for calibrating an unknown Doppler radar system.

The operator input device 200 can be in electrical communication with the motion controller 201. Electrical communication can be implemented using any means, such as wires, cables, or a printed circuit board. The process can further comprise actuating the Doppler radar calibrator target 202 in accordance with one or more motion profiles. Examples of motion profiles include sinusoidal, sawtooth, and random. The sinusoidal motion profile provides for smooth, periodic motion of the Doppler radar calibrator target 202. The sawtooth motion profile provides for motion that includes an abrupt change in direction or velocity. The random motion profile generates non-periodic motion of the Doppler radar calibrator target 202. The motion of the Doppler radar calibrator target 202 can cause a Doppler shift in a radio frequency wave reflected from the Doppler radar calibrator target 202. The process can further comprise illuminating the Doppler radar calibrator target 202 with a radio frequency wave. The radio frequency wave can be a continuous wave, or can be pulsed. The radio frequency wave can be generated by any suitable source, such as a radio frequency signal generator or an unknown Doppler radar system 204. The process can further comprise detecting the radio frequency wave reflected from the Doppler radar calibrator target 202. The reflected radio frequency wave can be detected using a receiver. The process can further comprise determining the Doppler shift of the radio frequency wave reflected from the Doppler radar calibrator target 202. The Doppler shift can be determined by comparing the frequency of the reflected radio frequency wave to the frequency of the source radio frequency wave. The Doppler radar calibrator target 202 can be a reversibly expandable bladder. The bladder can be made from any suitable material that is reflective to radio frequency waves and that can expand and contract. Actuating the Doppler radar calibrator target 202 can include expanding and contracting the Doppler radar calibrator target 202. The Doppler radar calibrator target 202 can be segmented. Each segment can be connected to a motion actuator. The motion actuators can be, for example, hydraulic, or pneumatic, or magnetic devices that impart motion. Actuating the Doppler radar calibrator target 202 can include simultaneously actuating a plurality of segments of the Doppler radar calibrator target 202.

Electrical communication between the operator input device 200 and the motion controller 201 allows for a more robust and reliable Doppler radar calibrator 203. Motion profiles enable the Doppler radar calibrator target 202 to simulate a wide range of motions. Illuminating the Doppler radar calibrator target 202 with a radio frequency wave provides a source wave for producing a test reflected RF wave 206. Detecting the reflected wave allows the unknown Doppler radar system 204 to be tested, and determining the Doppler shift provides a means for comparing the performance of the unknown Doppler radar system 204 to the known test Doppler shift 207 of the test reflected radio frequency wave 206. A reversibly expandable bladder enables the Doppler radar calibrator target 202 to be implemented with a wide variety of shapes and materials, and segmenting the Doppler radar calibrator target 202 allows for complex motion profiles to be realized. Simultaneous actuation of the segments provides a robust way to actuate the Doppler radar calibrator target 202.

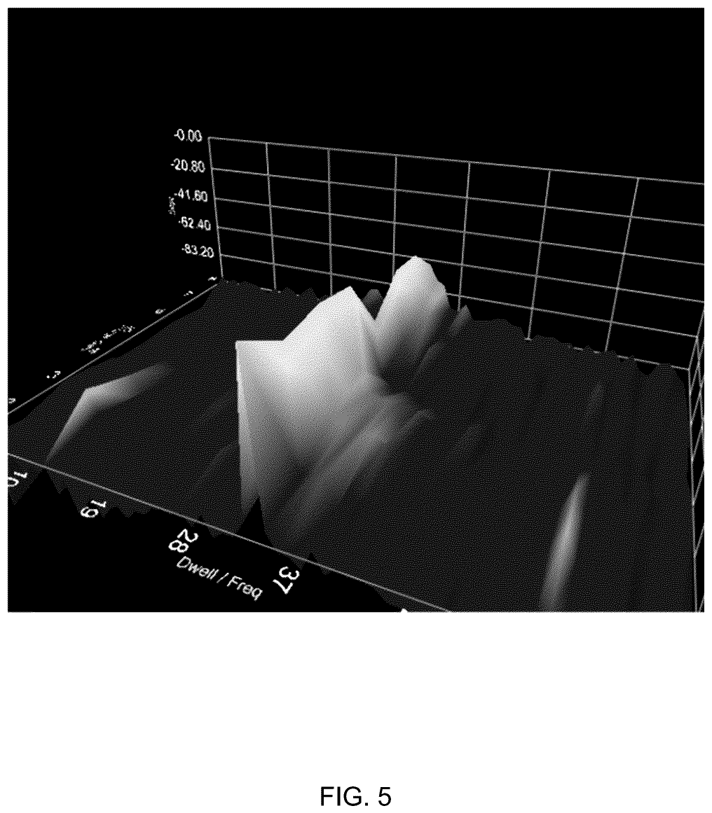

In an embodiment, with reference to FIG. 5, the graph shows data acquired from a Doppler radar calibrator 203 and displayed in range-Doppler format. The horizontal axis of the graph is frequency, or Doppler shift, and the vertical axis is the amplitude of the reflected signal.

In an embodiment, a process for determining whether an unknown Doppler radar system 204 is calibrated comprises illuminating a Doppler radar calibrator target 202 with a test source radio frequency wave 205. In an embodiment, the process further comprises actuating the Doppler radar calibrator target 202 by a Doppler radar calibrator 203 to move the Doppler radar calibrator target 202 with a frequency from 0.1 Hz to 10 Hz and with a displacement amplitude from 0.5 cm to 2 cm to produce a test reflected radio frequency wave 206 having a test Doppler shift 207. In an embodiment, the process further comprises receiving the test reflected radio frequency wave 206 by the unknown Doppler radar system 204. In an embodiment, the process further comprises determining a Doppler shift by the unknown Doppler radar system 204. In an embodiment, the Doppler radar calibrator target 202 interacts with the test source radio frequency wave 205 by reflection and scattering. In an embodiment, the reflection and scattering of the radio frequency wave from the Doppler radar calibrator target 202 is independent of the orientation of the Doppler radar calibrator target 202 with respect to a Doppler radar under test. In an embodiment, the process further comprises determining whether the Doppler shift determined by the unknown Doppler radar system 204 matches the test Doppler shift 207. In an embodiment, if the Doppler shift determined by the unknown Doppler radar system 204 matches the test Doppler shift 207, then the unknown Doppler radar system 204 is calibrated. In an embodiment, the Doppler radar calibrator target 202 is actuated in accordance with a motion profile comprising: sinusoidal, sawtooth, random, or a combination comprising at least one of the foregoing waveforms. In an embodiment, actuating the Doppler radar calibrator target 202 includes expanding and contracting the Doppler radar calibrator target 202. In an embodiment, the Doppler radar calibrator target 202 incorporates pieces that translate, rotate, or swing about an axis.

Conventional methods for calibrating Doppler radar systems use static targets that do not impart a Doppler shift onto a reflected radio frequency wave. It is therefore desirable to have a process for determining whether an unknown Doppler radar system 204 is calibrated that uses a moving target. The process illuminates a Doppler radar calibrator target 202 with a test source radio frequency wave 205. The test source RF wave 205 can be generated by any source, such as a radio frequency signal generator. The test source RF wave 205 can be a continuous wave or pulsed. The test source RF wave 205 can have any suitable frequency, such as a frequency in the range from 1 GHz to 10 GHz. The process actuates the Doppler radar calibrator target 202 by a Doppler radar calibrator 203 to move the Doppler radar calibrator target 202 with a frequency from 0.1 Hz to 10 Hz and with a displacement amplitude from 0.5 cm to 2 cm to produce a test reflected radio frequency wave 206 having a test Doppler shift 207. The Doppler radar calibrator 203 can be implemented using any method for imparting motion onto the Doppler radar calibrator target 202. The motion of the Doppler radar calibrator target 202 can be, e.g., sinusoidal, or sawtooth, or any motion profile. The process receives the test reflected radio frequency wave 206 by the unknown Doppler radar system 204. The test reflected radio frequency wave 206 can be received by a receiver that is part of the unknown Doppler radar system 204. The process determines a Doppler shift by the unknown Doppler radar system 204. The unknown Doppler radar system 204 can compare the received test reflected RF wave 206 to the test source RF wave 205 to determine the Doppler shift.

The Doppler radar calibrator target 202 interacts with the test source RF wave 205 by reflection and scattering. The Doppler radar calibrator target 202 can reflect a portion of the test source RF wave 205 back to the source, and the Doppler radar calibrator target 202 can scatter a portion of the test source RF wave 205. The angle of reflection of the radio frequency wave from the Doppler radar calibrator target 202 can be isotropic. An isotropic angle of reflection can be achieved by shaping the Doppler radar calibrator target 202 to approximate a sphere. The process can further comprise determining whether the Doppler shift determined by the unknown Doppler radar system 204 matches the test Doppler shift 207. The process can compare the Doppler shift determined by the unknown Doppler radar system 204 with the test Doppler shift 207 using a comparator circuit, or by another suitable method. If the Doppler shift determined by the unknown Doppler radar system 204 matches the test Doppler shift 207, then the unknown Doppler radar system 204 is calibrated. The Doppler radar calibrator target 202 can be actuated in accordance with one or more motion profiles. The motion profiles can include sinusoidal, sawtooth, and random motion profiles, or any other motion profiles. The Doppler radar calibrator target 202 can be actuated by expanding and contracting the Doppler radar calibrator target 202. Expansion and contraction of the Doppler radar calibrator target 202 can be achieved using any suitable means such as a pump that moves a fluid into and out of the Doppler radar calibrator target 202, or a linear actuator that pushes and pulls the Doppler radar calibrator target 202.

The Doppler radar calibrator target 202 interacts with the source wave 205 by reflection and scattering to provide a reflected wave having a Doppler shift. An isotropic angle of reflection provides for an accurate calibration process. Determining whether the Doppler shift measured by the unknown Doppler radar system 204 matches the test Doppler shift 207 provides a means for assessing the calibration of the unknown Doppler radar system 204. Actuating the Doppler radar calibrator target 202 using a variety of motion profiles provides a versatile method for testing the unknown Doppler radar system 204. Expanding and contracting the Doppler radar calibrator target 202 simulates a human chest motion. A reversibly expandable bladder allows the Doppler radar calibrator target 202 to be implemented using a variety of shapes and materials. Segmenting the Doppler radar calibrator target 202 and actuating a plurality of the segments simultaneously provides a method for emulating a human chest motion.

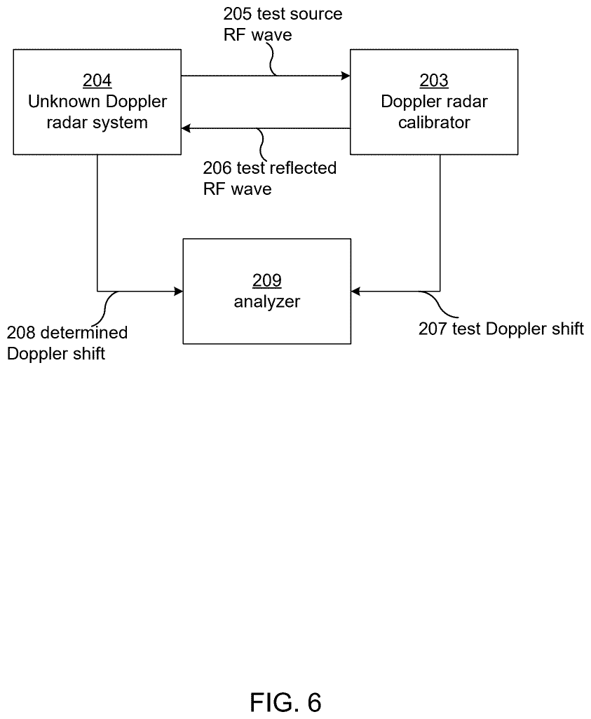

In an embodiment, with reference to FIG. 6, the drawing shows determining whether an unknown Doppler radar system 204 is calibrated. A test source RF wave 205 illuminates a Doppler radar calibrator 203. The Doppler radar calibrator 203 includes a Doppler radar calibrator target 202. The Doppler radar calibrator 203 actuates the Doppler radar calibrator target 202, which reflects the test source RF wave 205 to produce a test reflected RF wave 206. The test reflected RF wave 206 has a test Doppler shift 207. The unknown Doppler radar system 204 receives the test reflected RF wave 206 and determines a Doppler shift 208. The Doppler shift 208 determined by the unknown Doppler radar system 204 is compared to the known test Doppler shift 207 to determine whether the unknown Doppler radar system 204 is calibrated. The unknown Doppler radar system 204 can be, for example, a continuous wave Doppler radar system, a frequency modulated continuous wave Doppler radar system, or a pulsed Doppler radar system. The unknown Doppler radar system 204 can operate at any frequency.

It is contemplated that Doppler radar calibrator 203 can include the properties, functionality, hardware, and process steps described herein and embodied in any of the following non-exhaustive list:
a process (e.g., a computer-implemented method including various steps; or a method carried out by a computer including various steps);
an apparatus, device, or system (e.g., a data processing apparatus, device, or system including means for carrying out such various steps of the process; a data processing apparatus, device, or system including means for carrying out various steps; a data processing apparatus, device, or system including a processor adapted to or configured to perform such various steps of the process);
a computer program product (e.g., a computer program product including instructions which, when the program is executed by a computer, cause the computer to carry out such various steps of the process; a computer program product including instructions which, when the program is executed by a computer, cause the computer to carry out various steps);
computer-readable storage medium or data carrier (e.g., a computer-readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product);
a computer program product including comprising instructions which, when the program is executed by a first computer, cause the first computer to encode data by performing certain steps and to transmit the encoded data to a second computer; or
a computer program product including instructions which, when the program is executed by a second computer, cause the second computer to receive encoded data from a first computer and decode the received data by performing certain steps.

It should be understood that the calculations can be performed by any suitable computer system. Data is entered into a computing system via any suitable type of user interface and can be stored in memory, which can be any suitable type of computer readable and programmable memory and is preferably a non-transitory, computer readable storage medium. Calculations are performed by a processor, which can be any suitable type of computer processor and can be displayed to the user on a display, which can be any suitable type of computer display. The processor can be associated with, or incorporated into, any suitable type of computing device, for example, a personal computer or a programmable logic controller. The display, the processor, the memory, and any associated computer readable recording media are in communication with one another by any suitable type of data bus, as well. Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that can be used in addition to the memory, or in place of the memory, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable media include all computer-readable media except for a transitory, propagating signal.

The processes described herein can be embodied in, and fully automated via, software code modules executed by a computing system that includes one or more general purpose computers or processors. The code modules can be stored in any type of non-transitory computer-readable medium or other computer storage device. Some or all the methods can alternatively be embodied in specialized computer hardware. In addition, the components referred to herein can be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor can also include primarily analog components. For example, some or all of the signal processing algorithms described herein can be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions can be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

### Parts List

operator input device 200
motion controller 201
Doppler radar calibrator target 202
Doppler radar calibrator 203
unknown Doppler radar system 204
test source RF wave 205
test reflected RF wave 206
test Doppler shift 207

What is claimed is:

1. A Doppler radar calibrator 203, comprising: an operator input device 200 for specifying motion of a Doppler radar calibrator target 202; a motion controller 201 connected to the operator input device 200 and to the Doppler radar calibrator target 202, the motion controller 201 receiving information from the operator input device 200 and causing motion of the Doppler radar calibrator target 202 based on the information received; and a Doppler radar calibrator target 202, wherein the Doppler radar calibrator target 202 moves with a frequency from 0.1 Hz to 10 Hz and the Doppler radar calibrator target 202 moves with a displacement amplitude from 0.5 cm to 2 cm based on information from the motion controller 201.

2. The Doppler radar calibrator 203 of claim 1, wherein the motion controller 201 is in electrical communication with the operator input device 200.

3. The Doppler radar calibrator 203 of claim 1, wherein the motion controller 201 causes the Doppler radar calibrator target 202 to move in accordance with amotion profile comprising: sinusoidal, sawtooth, random, or a combination comprising at least one of the foregoing waveforms.

4. The Doppler radar calibrator 203 of claim 1, wherein the Doppler radar calibrator target 202 mimics human biometrics, the motion controller 201 controlling motion of the Doppler radar calibrator target 202 to simulate human heartbeat and respiration.

5. The Doppler radar calibrator 203 of claim 1, wherein the motion of the Doppler radar calibrator target 202 causes a Doppler shift in a radio frequency wave reflected from the Doppler radar calibrator target 202; wherein the Doppler radar calibrator target 202 interacts with the radio frequency wave by reflection and scattering; and wherein the angle of reflection of the radio frequency wave from the Doppler radar calibrator target 202 is isotropic.

6. The Doppler radar calibrator 203 of claim 1, wherein the Doppler radar calibrator target 202 is a reversibly expandable bladder.

7. The Doppler radar calibrator 203 of claim 1, wherein the Doppler radar calibrator target 202 is segmented; and wherein the motion controller 201 includes a plurality of motion actuators, each of the plurality of motion actuators connected to a segment of the Doppler radar calibrator target 202, wherein the motion controller 201 causes motion of the Doppler radar calibrator target 202 by simultaneous actuation of the plurality of motion actuators.

8. A process for operating a Doppler radar calibrator 203, comprising: receiving information from an operator input device 200 to define a motion of a Doppler radar calibrator target 202; transmitting the information to a motion controller 201; converting the information by the motion controller 201 into information for actuating a Doppler radar calibrator target 202; and actuating the Doppler radar calibrator target 202 by the motion controller 201 to move the Doppler radar calibrator target 202 with a frequency from 0.1 Hz to 10 Hz and with a displacement amplitude from 0.5 cm to 2 cm.

9. The process of claim 8, wherein the operator input device 200 is in electrical communication with the motion controller 201.

10. The process of claim 8, further comprising actuating the Doppler radar calibrator target 202 in accordance with a motion profile comprising: sinusoidal, sawtooth, random, or a combination comprising at least one of the foregoing waveforms.

11. The process of claim 8, wherein the motion of the Doppler radar calibrator target 202 causes a Doppler shift in a radio frequency wave reflected from the Doppler radar calibrator target 202.

12. The process of claim 11, further comprising:
illuminating the Doppler radar calibrator target 202 with a radio frequency wave;
detecting the radio frequency wave reflected from the Doppler radar calibrator target 202; and
determining the Doppler shift of the radio frequency wave reflected from the Doppler radar calibrator target 202.

13. The process of claim 8, wherein the Doppler radar calibrator target 202 is a reversibly expandable bladder.

14. The process of claim 8, wherein actuating the Doppler radar calibrator target 202 includes expanding and contracting the Doppler radar calibrator target 202.

15. The process of claim 8, wherein the Doppler radar calibrator target 202 is segmented and actuating the Doppler radar calibrator target 202 includes simultaneously actuating a plurality of segments of the Doppler radar calibrator target 202.

16. A process for determining whether an unknown Doppler radar system 204 is calibrated, the process comprising: illuminating a Doppler radar calibrator target 202 with a test source radio frequency wave 205; actuating the Doppler radar calibrator target 202 by a Doppler radar calibrator 203 to move the Doppler radar calibrator target 202 with a frequency from 0.1 Hz to 10 Hz and with a displacement amplitude from 0.5 cm to 2 cm to produce a test reflected radio frequency wave 206 having a test Doppler shift 207; receiving the test reflected radio frequency wave 206 by the unknown Doppler radar system 204; and determining a Doppler shift by the unknown Doppler radar system 204.

17. The process of claim 16, wherein the Doppler radar calibrator target 202 interacts with the test source radio frequency wave 205 by reflection and scattering;
and wherein the angle of reflection of the radio frequency wave from the Doppler radar calibrator target 202 is isotropic.

18. The process of claim 16, further comprising determining whether the Doppler shift determined by the unknown Doppler radar system 204 matches the test Doppler shift 207; and wherein if the Doppler shift determined by the unknown Doppler radar system 204 matches the test Doppler shift 207, then the unknown Doppler radar system 204 is calibrated.

19. The process of claim 16, wherein the Doppler radar calibrator target 202 is actuated in accordance with a motion profile comprising: sinusoidal, sawtooth, random, or a combination comprising at least one of the foregoing waveforms.

20. The process of claim 16, wherein actuating the Doppler radar calibrator target 202 includes expanding and contracting the Doppler radar calibrator target 202.

21. The process of claim 16, wherein the Doppler radar calibrator target 202 is a reversibly expandable bladder.

22. The process of claim 16, wherein the Doppler radar calibrator target 202 is segmented, the Doppler radar calibrator 203 including a motion controller 201, the motion controller 201 including a plurality of motion actuators; and wherein actuating the Doppler radar calibrator target 202 includes simultaneously actuating the plurality of motion actuators by the motion controller 201.
